(19) United States
(12) Patent Application Publication
(10) Pub. No.: US 2013/0201300 A1
(43) Pub. Date: Aug. 8, 2013

(54) IMAGING APPARATUS

(71) Applicant: Panasonic Corporation, Osaka (JP)

(72) Inventors: JUNPEI MATSUDA, Osaka (JP); TAKANORI YABUKI, Osaka (JP); KOICHI TOYOMURA, Osaka (JP); TSUYOSHI TOCHIO, Osaka (JP)

(73) Assignee: PANASONIC CORPORATION, Osaka (JP)

(21) Appl. No.: 13/752,508

(22) Filed: Jan. 29, 2013

(30) Foreign Application Priority Data
Jan. 30, 2012 (JP) 2012-016646

(51) Int. Cl. H04N 13/02

(52) U.S. Cl. CPC H04N 13/0203
USPC 348/49

(57) ABSTRACT

An imaging apparatus that can connect with a 3D conversion lens having an optical system capable of collecting light to form a left-eye image and light to form a right-eye image, includes an image pickup device, and an image processor that corrects distortion in image data captured by the image pickup device. The image processor applies distortion correction separately to each of image areas obtained by horizontally dividing the area of the image data captured by the image pickup device into two regions.

### BACKGROUND

1. Technical Field

The present disclosure relates to an imaging apparatus that can create side-by-side format three-dimensional (3D) images.

2. Related Art

JP-A-2006-52975 discloses a digital camera. This digital camera can compensate for specific lens distortion.

The digital camera disclosed in JP-A-2006-52975 corrects lens distortion that increases with distance from the image center.

Digital cameras that can capture 3D images are also known. One type of 3D digital camera captures side-by-side format 3D images created by imaging parallel right-eye and left-eye images with a single image pickup device. Distortion does not necessarily increase with distance from the image center in imaging apparatuses capable of capturing side-by-side format 3D images.

### SUMMARY

The present disclosure is directed to an imaging apparatus that achieves more appropriate distortion correction in an imaging apparatus capable of capturing side-by-side format 3D images.

In a first aspect, an imaging apparatus is provided which can connect with a 3D conversion lens having an optical system capable of collecting light to form a left-eye image and light to form a right-eye image. The imaging apparatus includes an image pickup device, and an image processor that corrects distortion in image data captured by the image pickup device. The image processor applies distortion correction separately to each of image areas obtained by horizontally dividing the area of the image data captured by the image pickup device into two regions.

In a second aspect, an imaging apparatus is provided that can connect with a 3D conversion lens having an optical system capable of collecting light to form a left-eye image and light to form a right-eye image. The imaging apparatus includes an image pickup device that captures a subject for a left eye and a subject for a right eye to generate image data when the 3D conversion lens is connected to the imaging apparatus, and an image processor that applies distortion correction separately to an image area for the left eye and an image area for the right eye in an image area represented by the image data captured by the image pickup device.

In a third aspect, an imaging apparatus is provided which includes an image pickup device that captures a subject for a left eye and a subject for a right eye in a side-by-side format to generate image data, and an image processor that applies distortion correction separately to an image area for the left eye and an image area for the right eye in an image area represented by the image data captured by the image pickup device.

The imaging apparatus according to the present disclosure can independently correct distortion in a left-eye image and a right-eye image, and can therefore apply distortion correction more appropriately to a side-by-side format 3D image.

### BRIEF DESCRIPTION OF DRAWINGS

FIG. 1 is an oblique view of a digital video camera with a 3D conversion lens attached;

FIG. 2 is an oblique view of the digital video camera with the 3D conversion lens removed;

FIG. 3 shows an example of a side-by-side format 3D image;

FIG. 4 is a block diagram showing the electrical configuration of a digital video camera;

FIG. 5 is a diagram showing the optical system of the digital video camera and the 3D conversion lens;

FIG. 6A shows an example of captured images with distortion;

FIG. 6B shows a distortion correction process applied to the captured images shown in FIG. 6A;

FIG. 6C shows distortion-corrected image data produced after applying the distortion correction process shown in FIG. 6B.

FIG. 7 is a diagram describing the algorithm used for distortion correction; and

FIG. 8 is a diagram describing generation of pixels after distortion correction.

### DETAILED DESCRIPTION OF EMBODIMENTS

Exemplary embodiments are described below with reference to the accompanying drawings. Note that excessively detailed description may be omitted. For example, detailed description of content that is already well-known, and redundant description of substantially identical elements, may be omitted or simplified. This is to avoid unnecessary redundancy in the following description, and to simplify understanding by those skilled in the related art. The accompanying figures and following description are provided to facilitate understanding by those skilled in the related art, and are not intended to limit the scope of the accompanying claims.

### 1. Embodiment 1

### 1-1 Overview

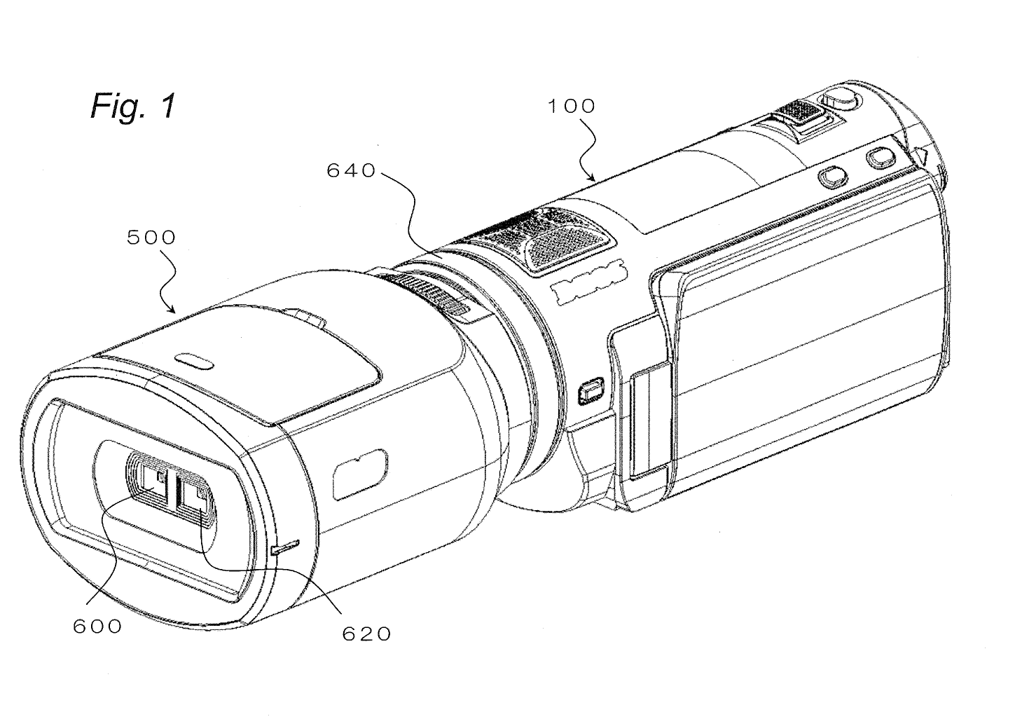

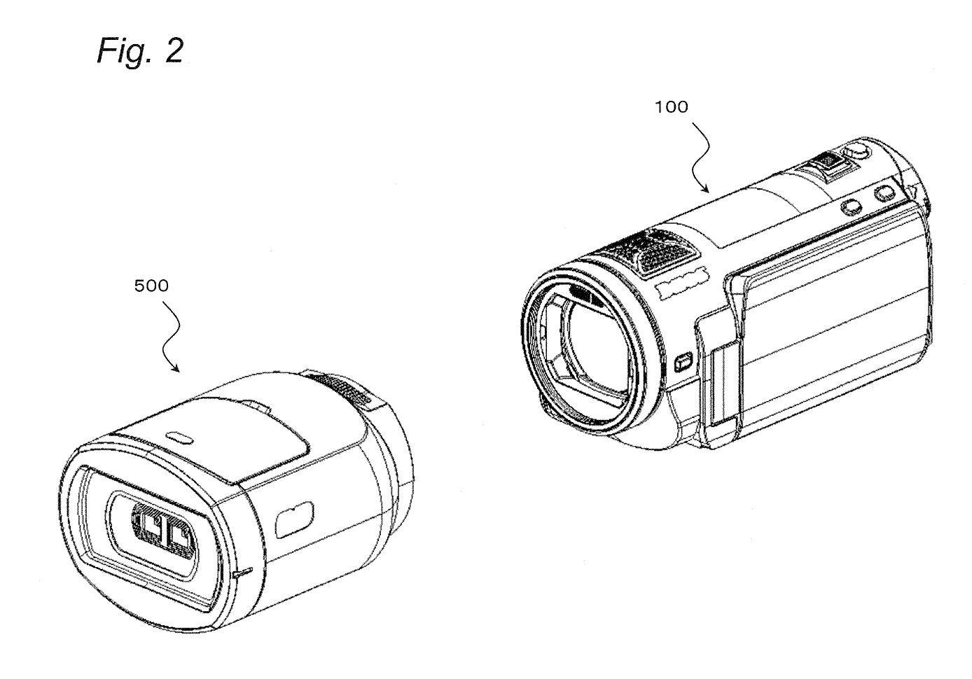

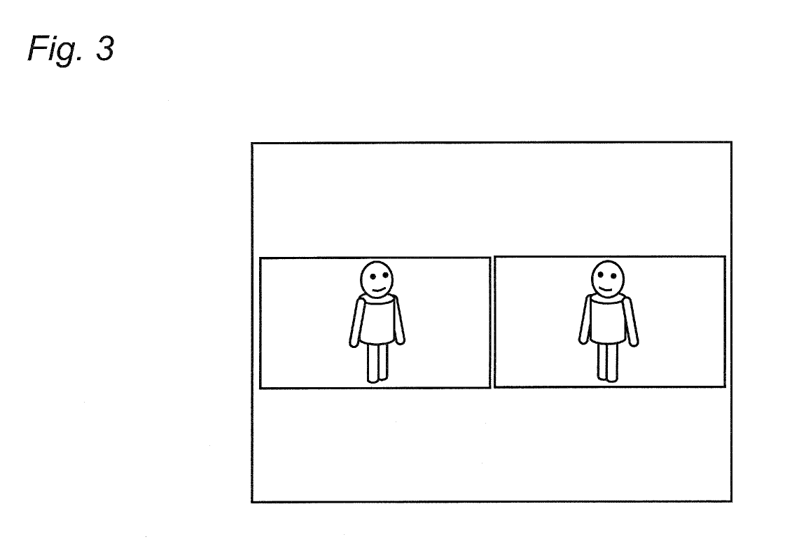

A digital video camera 100 according to the present embodiment is described briefly below with reference to FIG. 1 to FIG. 3. FIG. 1 is an oblique view showing the digital video camera 100 with a 3D conversion lens 500 attached. FIG. 2 is an oblique view showing the digital video camera 100 and the 3D conversion lens 500 when separated. FIG. 3 shows an example of an image captured by the digital video camera 100 with the 3D conversion lens 500 mounted.

The digital video camera 100 has a mounting unit 640 for mounting the 3D conversion lens 500. The mounting unit 640 has an internal female thread. The 3D conversion lens 500 has a male thread that screws together with the female thread of the mounting unit 640. The user attaches the 3D conversion lens 500 to the digital video camera 100 by screwing the male thread of the 3D conversion lens 500 into the female thread of the mounting unit 640. The digital video camera 100 also has a detection switch that can detect attachment of the 3D conversion lens 500.

The 3D conversion lens 500 has a left-eye lens 620 that guides light for forming an image for the left eye in the 3D (three-dimensional) image to the optical system of the digital video camera 100, and a right-eye lens 600 that guides light for forming a right-eye image to the optical system.

When the 3D conversion lens 500 is mounted, incident light from the subject passes through the optical systems of the 3D conversion lens 500 and the digital video camera 100. The incident light passing these optical systems converges as a side-by-side format 3D image as shown in FIG. 3 on the CMOS image sensor 140 of the digital video camera 100. The digital video camera 100 can capture 3D images as shown in FIG. 3, and store the images on a memory card 200 or other recording medium. Note that the side-by-side format 3D image shown in FIG. 3 actually represents the image after image processing of the image captured by the CMOS image sensor 140 for distortion correction and color correction, for example.

When the 3D conversion lens 500 is not mounted, incident light from the subject is imaged on the CMOS image sensor 140 after passing through only the optical system of the digital video camera 100. The digital video camera 100 captures the image formed on the CMOS image sensor 140 as a 2D (two-dimensional) image, and records the image on the memory card 200 or other recording medium. The mode in which 3D images are captured and recorded on the memory card 200 is referred to as a “3D mode” herein, and the mode in which 2D images are captured and recorded on the memory card 200 is referred to as a “2D mode”.

The digital video camera 100 according to this embodiment applies distortion correction differently when set to the 3D mode and when set to the 2D mode. More specifically, the digital video camera 100 according to this embodiment applies distortion correction that is more appropriate to side-by-side format 3D images when set to the 3D mode.

### 1-2 Configuration of Digital Video Camera

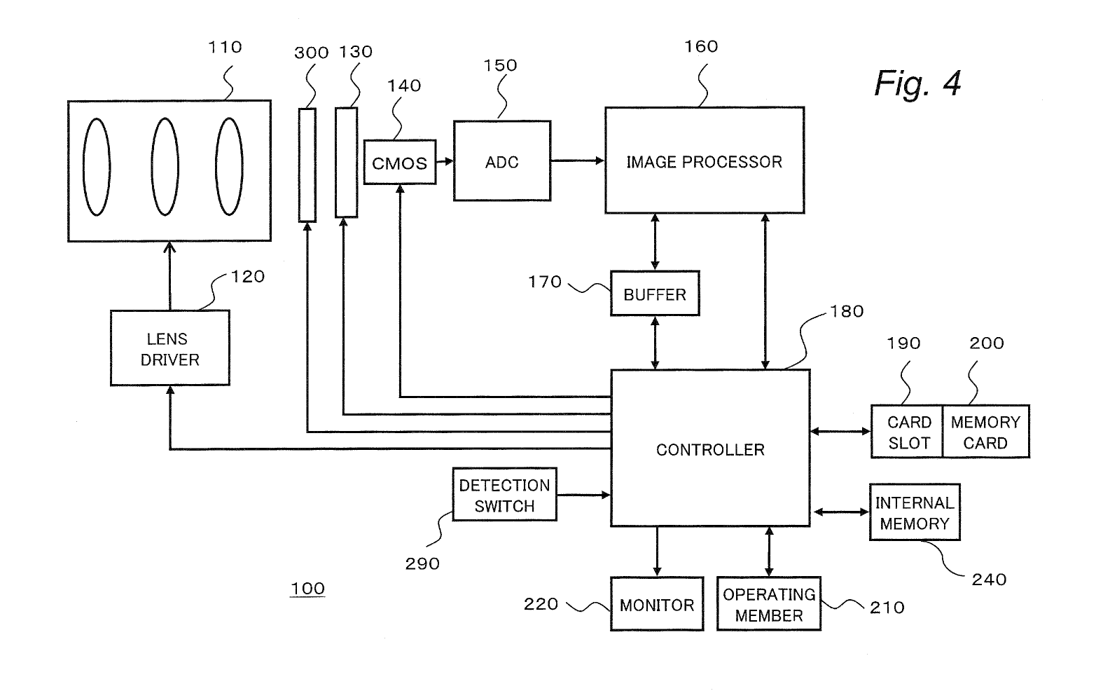

The electrical configuration of the digital video camera 100 according to this embodiment is described below with reference to FIG. 4. FIG. 4 is a block diagram showing the configuration of the digital video camera 100. The digital video camera 100 captures the subject image formed by an optical system 110 including one or a plurality of lenses, and generates image data, with the CMOS image sensor 140. The image data generated by the CMOS image sensor 140 is processed by an image processor 160, and stored on a memory card 200. The configuration of the digital video camera 100 is described more specifically below.

The optical system 110 includes a zoom lens and a focusing lens. The subject image can be enlarged and reduced by moving the zoom lens along the optical axis. The focus of the subject image can be adjusted by moving the focusing lens along its optical axis.

A lens driver 120 drives the lenses of the optical system 110. The lens driver 120 includes, for example, a zoom motor that drives the zoom lens, and a focus motor that drives the focusing lens.

The diaphragm 300 adjusts the size of the lens opening and adjusts how much light passes through either automatically or as set by the user.

A shutter 130 is a means for stopping light from passing through to the CMOS image sensor 140.

The CMOS image sensor 140 captures the subject image formed by the optical system 110, and generates image data. The CMOS image sensor 140 performs exposure, transmission, and electronic shutter operations.

An analog/digital converter (ADC) 150 converts the analog image data output by the CMOS image sensor 140 to digital image data.

An image processor 160 processes the image data generated by the CMOS image sensor 140 to produce image data for display on a monitor 220, and to produce image data for storing in the memory card 200. For example, the image processor 160 applies processes including gamma correction, white balance correction, and retouching to the image data generated by the CMOS image sensor 140. The image processor 160 also compresses the image data generated by the CMOS image sensor 140 using a compression method conforming to the H.264 or MPEG-2 standard, for example. The image processor 160 can be rendered using a DSP or microprocessor chip.

A controller 180 is the control means that controls general operation of the digital video camera. The controller 180 can be rendered by a semiconductor device, for example. The controller 180 can be rendered in hardware only, or by a combination of hardware and software. The controller 180 could be rendered with a microprocessor, for example.

A buffer 170 functions as working memory for the image processor 160 and controller 180. The buffer 170 can be rendered using DRAM or ferroelectric random access memory (FeRAM), for example.

A card slot 190 accommodates the memory card 200. The card slot 190 can connect mechanically and electrically to the memory card 200. The memory card 200 contains flash memory or FeRAM, for example, and can store data including image files generated by the image processor 160.

The internal memory 240 is rendered by flash memory or FeRAM, for example. The internal memory 240 stores the control program for controlling the digital video camera 100, for example.

An operating member 210 refers generally to the user interface through which user operations are received. The operating member 210 includes, for example, a cursor key and enter button through which user operations are received.

The monitor 220 can display images (through images) represented by the image data generated by the CMOS image sensor 140, and images represented by image data read from the memory card 200. The monitor 220 can also display menus and prompts for operating and configuring the digital video camera 100.

A detection switch 290 magnetically detects attachment of the 3D conversion lens 500 to the digital video camera 100. Attachment of the 3D conversion lens 500 could alternatively be detected electrically or mechanically.

### 1-3 Optical Systems of 3D Conversion Lens and Digital Video Camera

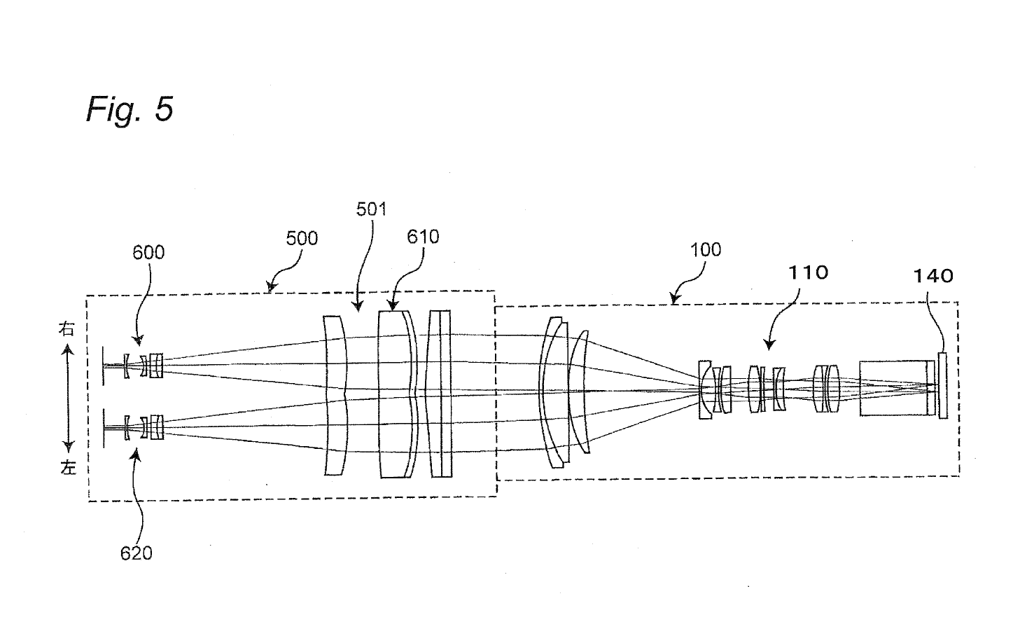

FIG. 5 describes the configuration of the optical system 501 of the 3D conversion lens 500 and the optical system 110 of the digital video camera 100. The optical system. 501 of the 3D conversion lens 500 includes a right-eye lens 600 that guides light for forming the image for the right eye in the 3D image, a left-eye lens 620 that guides light for forming the image for the left eye, and a common lens 610 that combines the left- and right-eye images and guides light from the right-eye lens 600 and left-eye lens 620 to the optical system 110 of the digital video camera 100. Light incident to the right-eye lens 600 and left-eye lens 620 of the 3D conversion lens 500 passes through the common lens 610 to the optical system 110 of the digital video camera 100, and is imaged up as a side-by-side image such as shown in FIG. 3 by the CMOS image sensor 140 of the digital video camera 100.

### 1-4 Operation

The operation of the digital video camera 100 thus comprised is described below.

### 1-4-1 Overview of Distortion Correction in 3D Mode

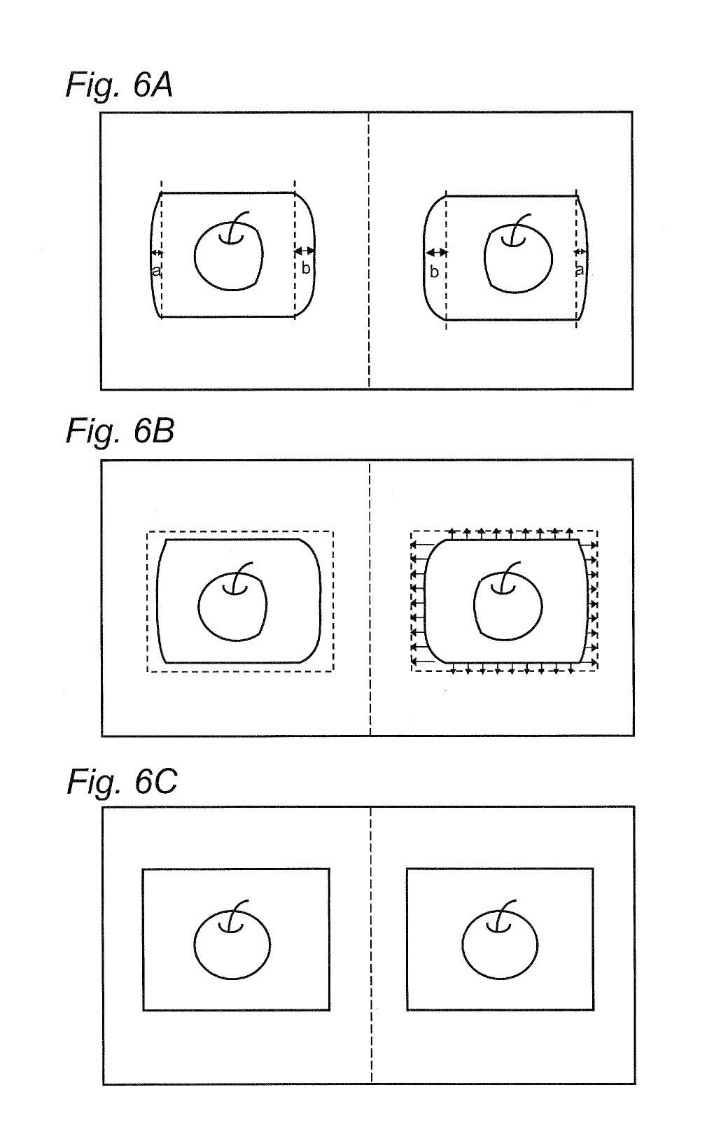

Distortion correction performed when the digital video camera 100 is set to the 3D mode is outlined below. FIG. 6 illustrates distortion correction in the 3D mode.

When images are recorded by the digital video camera 100 with the 3D conversion lens 500 attached, images are formed on the CMOS image sensor 140 by the incident light passing through the two optical systems 501 and 110. As a result, the images that are formed are subject to distortion by both the optical system 501 of the 3D conversion lens 500 and the optical system 110 of the digital video camera 100.

FIG. 6A shows images captured by the CMOS image sensor 140 with lens distortion when the 3D conversion lens 500 is attached. In the example shown in FIG. 6A, distortion b closer to the center of the image is greater than distortion a towards the outside edge. More specifically, distortion is greater towards the horizontal center of the image than at the horizontal outside edges. This is because the distortion produced by the 3D conversion lens 500 is sufficiently greater than the distortion produced by the optical system 110 of the digital video camera 100 in this embodiment. Note that when the lens distortion produced by the 3D conversion lens 500 is sufficiently less than the distortion produced by the optical system 110, distortion a is longer than distortion b.

The image processor 160 then applies a distortion correction process as shown in FIG. 6B to the image captured by the CMOS image sensor 140. In this process, the image processor 160 corrects lens distortion by extending the position of each pixel in the images used for perspective in the side-by-side image data containing distortion to the outside both horizontally and vertically. More specifically, the image processor 160 corrects distortion by using the pixels in the image data captured by the CMOS image sensor 140 to generate pixels at different positions in the image after the distortion correction process is applied. This distortion correction process is described in detail below.

Distortion-corrected image data such as shown in FIG. 6C can be produced by applying the distortion correction process shown in FIG. 6B to the image data shown in FIG. 6A.

### 1-4-2 Algorithm for Correcting Distortion in 3D Mode

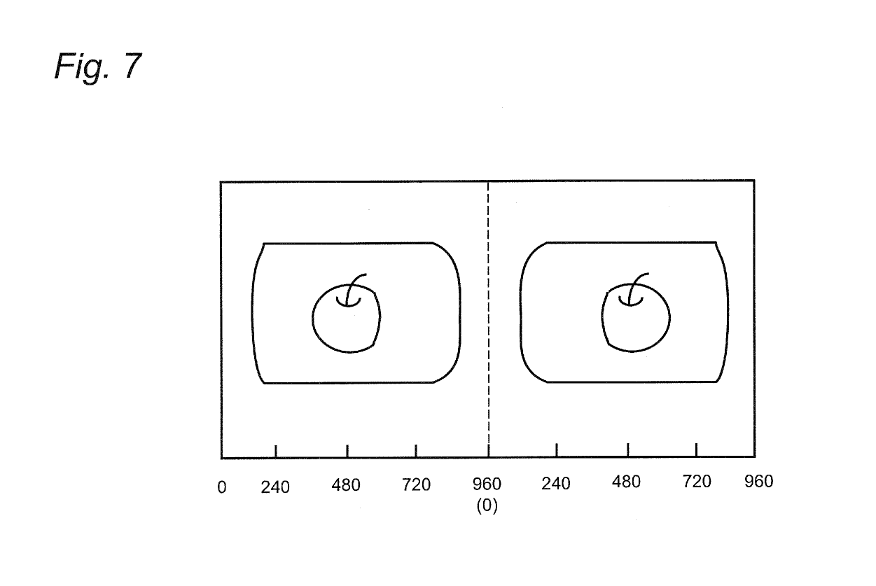

The algorithm for correcting distortion in the 3D mode is described next. The horizontal coordinate axis of the image data is referred to as the x-axis in this algorithm. Each pixel in the image data is assigned to a specific coordinate on the x-axis. As shown in FIG. 7, there are 1920 horizontal pixels in this embodiment. Note that for brevity this embodiment only describes correcting horizontal distortion (on the x-axis), but distortion on the vertical axis can be corrected in the same way. Horizontal correction is applied in the same way at all vertical coordinates.

The digital video camera 100 stores, for each pixel, a correction factor which is used to determine which pixels in the image before distortion correction to use in order to generate the pixels in the distortion-corrected image. More specifically, the digital video camera 100 stores correction factors for pixels at nine representative points on the x-axis.

Table 1 and Table 2 below show the correction factors (parameter) for pixels at five points on the x-axis in the left and right images shown in FIG. 7. The information related to the correction factors of the representative pixels is stored in internal memory 240. The image processor 160 corrects distortion in the left-eye image using the parameters shown in Table 1, and corrects distortion in the right-eye image using the parameters shown in Table 2. Distortion is thus corrected using different parameters for the left and right images. Note that as shown in the tables the correction factors for the left and right images (the parameters used for distortion correction) are asymmetric to the pixel at the horizontal center (x=480) of each of left-eye and right-eye images.

TABLE 1
Correction factors for the left image

| | x | | | | |
|---|---|---|---|---|---|
| | 0 | 240 | 480 | 720 | 960 |
| Correction | −0.1 | −0.05 | 0 | 0.05 | 0.2 |
| factor | | | | | |

TABLE 2
Correction factors for the right image

| | x | | | | |
|---|---|---|---|---|---|
| | 0 | 240 | 480 | 720 | 960 |
| Correction | −0.2 | −0.05 | 0 | 0.05 | 0.1 |
| factor | | | | | |

The image processor 160 can calculate the correction factor for the pixels other than the representative pixels using equation (1) below based on the correction factors for the representative pixels shown in Tables 1 and 2. Equation (1) is a linear function producing a linear change in the correction factors of the representative pixels. Note also that xa and xa+1 denote any two consecutive values in the x coordinates shown in Table 1 and Table 2.

correction factor x={(correction factor xa+1−correction factor xa)/(xa+1−xa)}×(x−xa)+correction factor xa (1)

Based on the calculated correction factor, the image processor 160 then uses equation (2) below to calculate the movement, which is the difference between the position of each pixel and the position of the pixel before distortion correction that was used to generate each pixel. This equation (2) is an equation for converting the correction factor of each pixel to the scale of the 960 pixels viewed on one side of the side-by-side format 3D image.

movement x=960×correction factor x (2)

The image processor 160 can calculate the position of the pixel to be referenced in the image before distortion correction by calculating the difference between the position of the pixel to be generated and the calculated movement. Using equation (1) and equation (2), each pixel in the image data near the horizontal center of the image data captured by the CMOS image sensor 140 is used to generate a pixel positioned closer to the center than the position before distortion correction. In addition, each pixel in the image data toward the outside edges is used to generate a pixel at a position even further to the outside.

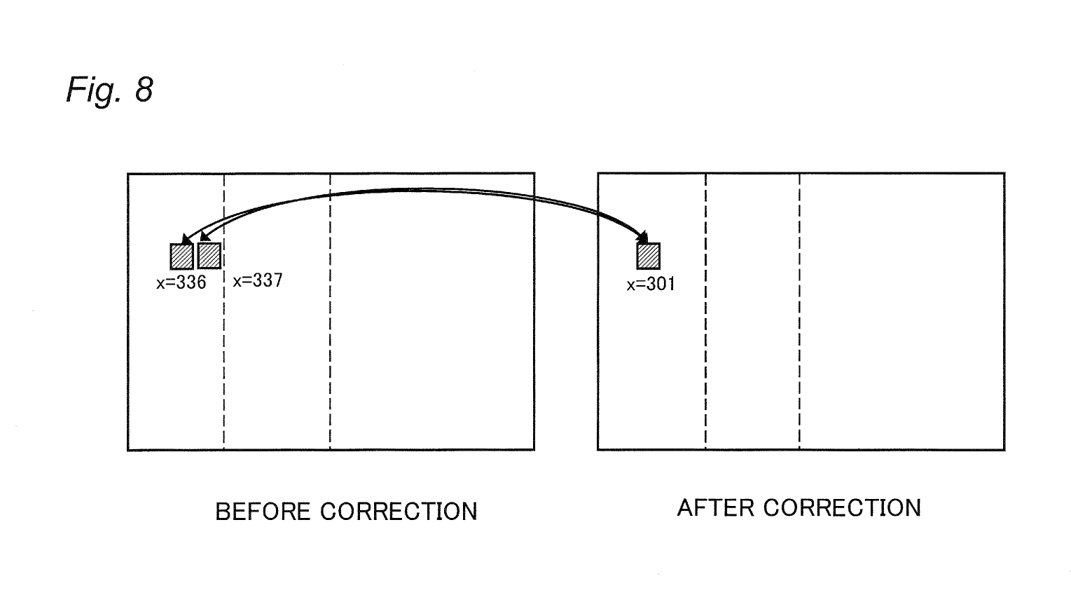

A specific example of distortion correction in the left-eye image is described below using equation (1), equation (2), Table 1, and FIG. 8. This example describes a method of calculating which pixel in the image before distortion correction to use to generate the pixel at horizontal position (x coordinate) of 301. In this example, xa=240 and xa+1=480 in equation (1).

By substituting x=301, xa=240, xa+1=480 in equation (1), correction factor x is obtained as follows.

correction factor x={(0−(−0.05))/(480−240)}×(301−240)+(−0.05)≈0.0373

In equation (2), 0.0373 is then inserted for correction factor x, resulting in movement=−35.8. Because 35<35.8<36, pixels x=336 (=301+35) and x=337 (=301+36) in the image data before distortion correction are used in order to calculate the pixel at pixel position x=301. More specifically, as shown in FIG. 8, the two pixels at positions x=336 and x=337 before distortion correction are used to generate the pixel at x=301 in the image after distortion correction. Note that the position of the corresponding pixel before distortion correction can be calculated by subtracting the movement from the x coordinate of the pixel position to be generated.

The image processor 160 of the digital video camera 100 according to this embodiment thus uses pixels in the area closer to the horizontal center of the area of the image before distortion correction (the area closer to the boundary between the left-eye image and the right-eye image) to generate pixels at positions closer to the center than those pixels in the image after distortion correction. As a result, distortion is corrected in opposite directions at the boundary between the left-eye image and right-eye image when recording side-by-side format 3D images.

### 1-5 Effect, and so on

As described above, a digital video camera 100 according to this embodiment is an imaging apparatus that is connectable to a 3D conversion lens 500 having an optical system capable of collecting light for forming a left-eye image and light for forming a right-eye image. The digital video camera 100 has a CMOS image sensor 140 and an image processor 160 that corrects lens distortion in the image data captured by the CMOS image sensor 140. The image processor 160 applies distortion correction separately to image areas acquired by dividing the area of the image data captured by the imaging apparatus into two regions horizontally. With this digital video camera 100, when the left and right images have different distortion characteristics, distortion correction that is appropriate to the specific distortion characteristics of the two areas can therefore be applied.

### 2. Other Embodiments

A preferred embodiment is described above as an example of the technology disclosed herein. However, the technology in this disclosure is not limited thereto, and can also be applied to other embodiments including desirable changes, substitutions, additions, or subtractions. Other embodiments are also possible by combining elements of the first embodiment described above in other ways. Examples of other embodiments are described below.

A CMOS image sensor 140 is described as an example of the image pickup device (or imaging unit) in the foregoing embodiment, but the image pickup device is not limited thereto. For example, a CCD image sensor or NMOS image sensor may be used for the image pickup device.

The image processor 160 and controller 180 could also be rendered on a single semiconductor chip, or on separate semiconductor chips.

The operation and configuration for correcting distortion in a digital video camera 100 to which a 3D conversion lens 500 can be attached are described above. However the concept of the foregoing embodiment described above can also be applied to a digital video camera originally having two optical systems (twin-lens). The concept of the foregoing embodiment can also be applied to imaging apparatuses that have separate left and right optical systems and capture side-by-side images with a single image pickup device.

In the foregoing embodiment, the distortion correction for the image captured in the side-by-side format is described, for the digital video camera 100 with the 3D conversion lens 500 attached. For the digital video camera 100 with no 3D conversion lens 500 attached, distortion correction to be performed for a normal 2D image may be done.

The foregoing embodiments are described as non-exhaustive examples of the technology of the present disclosure disclosed herein, and the accompanying figures and detailed description are provided for this purpose.

The elements described in the accompanying figures and detailed description therefore include, in addition to elements that are necessary to solve the problem described above, elements that are not necessary to solve the foregoing problem but are useful for describing the technology of the embodiment. Therefore, even though elements that are not essential are described in the accompanying figures and detailed description, it should not be construed that non-essential elements are essential.

The foregoing embodiment is described above using a digital video camera as an example of an imaging apparatus, but it will be obvious to one with ordinary skill in the related art that the technical concept disclosed in the foregoing embodiment can also be applied to imaging apparatuses other than digital video cameras. More specifically, the concept of the foregoing embodiment can be applied to any imaging apparatus having a different distortion characteristic in left and right image areas obtained by dividing the captured area of the pickup device into two parts horizontally.

The foregoing embodiments are for describing the technology disclosed by the present disclosure, and changes, substitutions, additions, and subtractions within the scope of the accompanying claims and the equivalent are possible.

### INDUSTRIAL APPLICABILITY

The present disclosure can be applied to imaging apparatuses such as digital video cameras and digital still cameras that capture left and right images enabling a three-dimensional view with a single image pickup device.

What is claimed is:

1. An imaging apparatus that can connect with a 3D conversion lens having an optical system capable of collecting light to form a left-eye image and light to form a right-eye image, the imaging apparatus comprising:
an image pickup device operable to capture image data; and
an image processor operable to correct distortion in the image data captured by the image pickup device,
wherein the image processor applies distortion correction separately to each of image areas obtained by horizontally dividing an area of the image data captured by the image pickup device into two regions.

2. The imaging apparatus according to claim 1, wherein a parameter used for the distortion correction in each image area denotes asymmetric values referenced to a horizontal center of each image area.

3. The imaging apparatus according to claim 1, wherein the image processor uses a first pixel in an area near the horizontal center of the image before distortion correction to generate a second pixel at a position closer than the first pixel to the center of the image after distortion correction.

4. The imaging apparatus according to claim 1, wherein the image pickup device captures a left-eye image and a right-eye image in a side-by-side format.

5. An imaging apparatus that can connect with a 3D conversion lens having an optical system capable of collecting light to form a left-eye image and light to form a right-eye image, the imaging apparatus comprising:
an image pickup device operable to capture a subject for a left eye and a subject for a right eye to generate image data when the 3D conversion lens is connected to the imaging apparatus; and
an image processor operable to apply distortion correction separately to an image area for the left eye and an image area for the right eye in an image area represented by the image data captured by the image pickup device.

6. The imaging apparatus according to claim 5, wherein
a parameter used for the distortion correction in the image area for the left eye denotes asymmetric values referenced to a horizontal center of the image area for the left eye, and
a parameter used for the distortion correction in the image area for the right eye denotes asymmetric values referenced to a horizontal center of the image area for the right eye.

7. An imaging apparatus comprising:
an image pickup device operable to capture a subject for a left eye and a subject for a right eye in a side-by-side format to generate image data; and
an image processor operable to apply distortion correction separately to an image area for the left eye and an image area for the right eye in an image area represented by the image data captured by the image pickup device.

8. The imaging apparatus according to claim 7, wherein
a parameter used for the distortion correction in the image area for the left eye denotes asymmetric values referenced to a horizontal center of the image area for the left eye, and
a parameter used for the distortion correction in the image area for the right eye denotes asymmetric values referenced to a horizontal center of the image area for the right eye.
